(19) United States
(12) Patent Application Publication
(10) Pub. No.: US 2005/0114382 A1
(43) Pub. Date: May 26, 2005

(54) Method and system for data segmentation

(76) Inventors: Choudur K. Lakshminarayan, Leander, TX (US); Pramond Singh, Austin, TX (US); Qingfeng Yu, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/871,148

(22) Filed: Jun. 18, 2004

Related U.S. Application Data
(60) Provisional application No. 60/525,388, filed on Nov. 26, 2003.

(51) Int. Cl. G06F 17/00

(52) U.S. Cl. 707/102

(57) ABSTRACT

One exemplary method comprises a method for grouping a plurality of data elements of a dataset. The method includes clustering the dataset into a plurality of clusters with each of the plurality of clusters including at least one of the plurality of data elements. The method further includes iteratively classifying the plurality of clusters into a plurality of classes of like data elements.

### CROSS-REFERENCE TO RELATED APPLICATION

Pursuant to the provisions of 35 U.S.C. § 119(e), this application claims the benefit of the filing date of provisional patent application Ser. No. 60/525,388, filed Nov. 26, 2003.

### BACKGROUND

It is often advantageous in the utilization of data to identify or discover previously unknown relationships among a collection of data elements. Such a relationship-discovery process has commonly become known as “data mining,” which has been more particularly defined as a technique by which hidden patterns are identified in a collection of data elements. Data mining is typically implemented as a software or other algorithmic process which is performed upon a collection or database of information or observations. Various generalized techniques have come to the forefront and include, among others, clustering which is a useful technique for exploring and visualizing data. Such a technique is particularly helpful in applications where a significant amount of data is present or a lesser amount of data is present having a significant number of dimensions or attributes.

With the advent of high-speed computing, there has been a renewed interest in clustering research. Various algorithms have emerged to cluster datasets having different characteristics. Clustering methods can be roughly divided into partitioning and hierarchical methods. Partitioning methods and algorithms include k-means, expectation maximization “EM” and k-medoid algorithms, among others. While the aforementioned algorithms are relatively effective with certain types of datasets, such algorithms have heretofore required that the quantity of clusters be explicitly specified prior to the application of the clustering algorithm on the specified dataset. However, applications for data segmentation exist wherein a priori knowledge of the number of clusters may not be available, for example, when clustering segmentation is itself the initial step in the analysis of a dataset.

Hierarchal clustering methods include agglomerative which consolidates and divisive approaches which split the dataset recursively into smaller and ever smaller clusters. The output of a hierarchical clustering method may be configured as dendrogram or tree structure which is helpful in understanding the dataset segmentation but generally requires the identification of a proper threshold to arrive at an acceptable number of partitions.

### BRIEF SUMMARY OF THE INVENTION

In one embodiment of the present invention, a method is provided for grouping a plurality of data elements of a dataset. A dataset is clustered into a plurality of clusters with each cluster further including at least one data element. The data elements within clusters are then iteratively classified into a plurality of classes with each class generally including like data elements.

In another embodiment of the present invention, a method is provided for segmenting a dataset including a plurality of data elements into a plurality of groups, each having at least one like property. A dendrogram is initialized with the plurality of data elements of the dataset. For each open node of the dendrogram, the dataset is clustered and iteratively classified according to a discriminant analysis algorithm configured to move at least one of the plurality of data elements from one of the plurality of classes to another one of the plurality of classes until misclassification of the plurality of data elements approaches a minimum. When adequate separability of the classes exists, the classes are accepted as acceptably partitioned nodes of the dendrogram, otherwise the node from which the clusters originated is closed to further splitting.

In yet another embodiment of the present invention, a system for grouping a plurality of data elements forming a dataset into a plurality of groups is provided. The system includes a sensor for detecting the plurality of data elements to form the dataset and a memory for storing the plurality of data elements. The system further includes a processor for clustering the dataset into a plurality of clusters, each of the plurality of clusters comprising at least one of the plurality of data elements. The clusters are then iteratively classified into a plurality of classes of like data elements.

In yet a further embodiment of the present invention, a computer-readable medium having computer-readable instructions thereon for grouping a plurality of data elements of a dataset is provided. The computer-readable medium includes computer-readable instructions for performing the steps of clustering the dataset into a plurality of clusters, each of the plurality of clusters comprising at least one of the plurality of data elements. The computer-readable instructions are further configured to iteratively classify the plurality of clusters into a plurality of classes of like data elements.

In yet a further embodiment of the present invention, a system for grouping a plurality of data elements of a dataset is provided. The system includes a means for clustering the dataset into a plurality of clusters with each of the plurality of clusters including at least one of the plurality of data elements. The system further includes a means for iteratively classifying the plurality of clusters into a plurality of classes of like data elements.

### DESCRIPTION OF THE SEVERAL VIEWS OF THE DRAWINGS

FIG. 1 is a flowchart of a method for grouping a plurality of data elements, in accordance with an embodiment of the present invention;

FIG. 2 is an exemplary plot of data elements distinguished by actual properties which represent an ideal grouping of the data elements;

FIG. 3 is an exemplary clustering of the data elements of FIG. 1 following a clustering process, in accordance with an embodiment of the present invention;

FIG. 4 is an exemplary grouping of the data elements as clustered in FIG. 3 following a first iteration of a classification process, in accordance with an embodiment of the present invention;

FIG. 5 is an exemplary grouping of the data elements as classified in FIG. 4 following a second iteration of a classification process, in accordance with an embodiment of the present invention;

FIG. 6 is an exemplary grouping of the data elements as classified in FIG. 5 following a third iteration of a classification process, in accordance with an embodiment of the present invention;

FIG. 7 is an exemplary grouping of the data elements as classified in FIG. 6 following a fourth iteration of a classification process, in accordance with an embodiment of the present invention;

FIG. 8 is a plot of a trace of a covariance matrix of one class or grouping of data elements through several iterations of the classification process performed on the classes of data elements, in accordance with an embodiment of the present invention;

FIG. 9 is another plot of a trace of a covariance matrix of another class or grouping of data elements through several iterations of the classification process performed on the classes of data elements, in accordance with an embodiment of the present invention;

FIG. 10 is a plot of misclassification of data elements of the respective classification process iterations of FIGS. 4-7 as compared with the ideal classification of FIG. 1 for identifying inflection points of interest on the plots of FIGS. 8-9, in accordance with an embodiment of the present invention;

FIG. 11 is a graphing of misclassification rates as a function of class separability of various dimensioned datasets, in accordance with an embodiment of the present invention;

FIG. 12 is a plot illustrating a comparison of misclassifications of observations or data elements of a clustering-only approach as contrasted with a combined clustering and classification method, in accordance with an embodiment of the present invention;

FIG. 13 is an exemplary plot of a higher classification dimension of data elements distinguished into four classes by actual properties which represent an ideal grouping of the data elements;

FIG. 14 is an exemplary clustering of the data elements of FIG. 13 following a clustering process, in accordance with an embodiment of the present invention;

FIG. 15 is an exemplary grouping of the data elements as clustered in FIG. 14 following a first iteration of a classification process, in accordance with an embodiment of the present invention;

FIG. 16 is an exemplary grouping of the data elements as classified in FIG. 15 following a second iteration of a classification process, in accordance with an embodiment of the present invention;

FIG. 17 is an exemplary grouping of the data elements as classified in FIG. 16 following a third iteration of a classification process, in accordance with an embodiment of the present invention;

FIG. 18 is an exemplary grouping of the data elements as classified in FIG. 17 following a fourth iteration of a classification process, in accordance with an embodiment of the present invention;

FIGS. 19 and 20 are a table and plot consisting of the relative likelihood of conversion (RLC) and a corresponding technographic index value, in accordance with an embodiment of the present invention;

FIG. 21 is a high level block diagram of a system for gathering and grouping elements from a dataset, according to an embodiment of the present invention;

FIG. 22 is a flowchart of a method for grouping a plurality of data elements in a dataset, in accordance with an embodiment of the present invention; and

FIG. 23 is a flowchart of a method of segmenting a dataset including a plurality of elements into a plurality of groups each having at least one like property, in accordance with an embodiment of the present invention.

### DETAILED DESCRIPTION OF THE INVENTION

It is advantageous to partition data elements or observations into groups having similar attributes or properties prior to performing predictive analysis upon the data. Processes for grouping or “clustering” data have been devised but have resulted in significant “miscalculation” of data elements or “observations” into incorrect or less than ideal groups which further affects predictions based upon the inaccurately classified or group data elements.

Many data-partitioning clustering methods, including the k-means algorithm, prefer the quantity of clusters to be explicitly assigned prior to the grouping of data elements. In at least some of the various embodiments of the present invention, a hierarchical divisive clustering structure is provided by performing an initial clustering-based partitioning of the dataset and performing an iterative discriminant analysis classification process on the clustered dataset. The a priori knowledge of the quantity of groups becomes unnecessary as a class separability measure including a class separability threshold is defined, which obviates pre-selection of the quantity of individual clusters. Iterative discriminant analysis is employed in conjunction with a clustering scheme to further improve the grouping accuracy.

As a general application of the improved data partitioning methodology of at least some of the various embodiments of the present invention, a method identified herein as a hierarchical divisive clustering process, finds applications relating to modeling behavior of, for example, anonymous online visitors based on a variety of, for example, click stream attributes to better target marketing campaigns. To facilitate data mining, including exploratory data analysis and predictive modeling, clustering methods are implemented in conjunction with classification schemes, which address asymmetrical covariance structures in the clusters, to provide more accurate classification of data elements than could otherwise be obtained by traditional clustering algorithms alone.

Distinct groupings of data elements are identified from a dataset using a two-stage clustering and classification approach to derive a homogeneous set of observations within each cluster. The two-stage scheme is an improvement over a clustering-only approach, at least in part, because clustering techniques alone, such as a k-means clustering algorithm, result in sub-optimal clusters due to cluster sizes and shapes that may be non-spherical blobs of varying sizes.

As stated, clustering algorithms are roughly divided into partitioning and hierarchical methods. Partitioning methods include k-means algorithms, EM algorithm and k-medoid algorithm, among others. Hierarchical methods generally include two separate clustering approaches, namely agglomerative and divisive clustering. The data segmentation or partitioning method may be herein referred to as a hierarchical divisive grouping process and includes treating the entire dataset as one super-cluster and decomposing the super-cluster recursively into component groups. The recursive process continues until each individual observation forms a group or until the splitting results in groups with smaller number of observations than the pre-defined minimum. To determine if a group or class should be further divided, a class separability (C-S) measure is defined which measures the distance between other classes. When the C-S measure exceeds a predefined threshold, the grouping process is terminated by accepting the proposed splitting of the group or “node,” otherwise the group as split is not accepted and the original node is closed from further splitting attempts.

Specifically, in the first stage, namely the clustering phase, a clustering process is applied to group a set of data elements. By way of example and not limitation, the dataset comprising a plurality of data elements or observations is grouped or clustered using, for example, a k-means algorithm. The resulting clusters are desirably relatively homogonous groups such that the cluster variance within each cluster is small with the distance between clusters being as large as possible. Specifically, the technique for partitioning homogeneous items into k groups given an optimization criterion is an iterative optimization technique. Furthermore, clustering data elements according to the k-means algorithm alone only results in sub-optimal clusters for the aforementioned reasons.

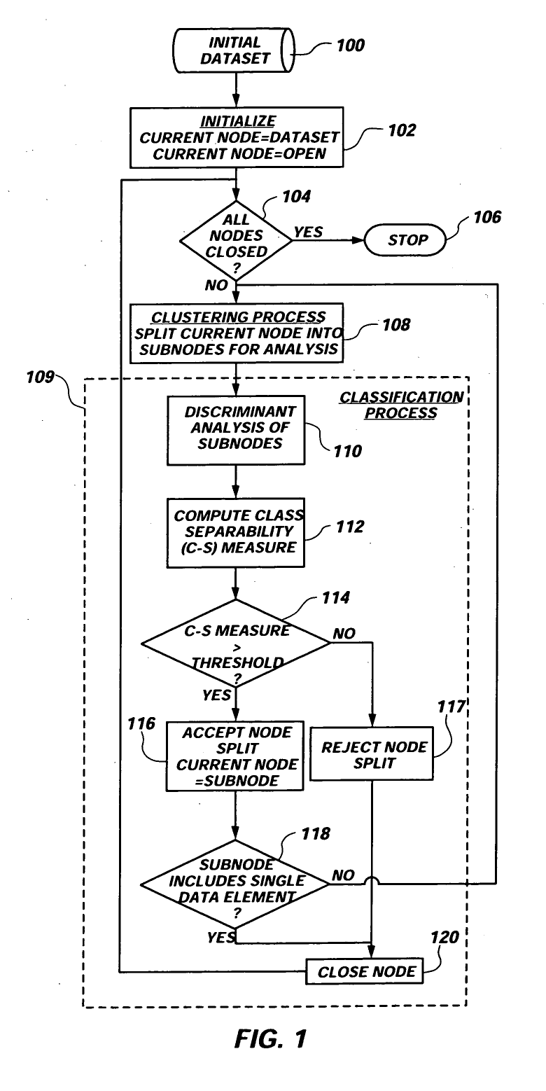

FIG. 1 is a flowchart for accommodating the grouping of elements from an initial dataset, in accordance with an embodiment of the present invention. As stated, grouping methods, such hierarchal methods, may be generally classified into two specific types, namely agglomerative and divisive grouping techniques. Hierarchal divisive clustering or grouping begins by treating an entire dataset 100 as a super-cluster or an initial dendrogram node formed through an initialization 102 which is decomposed recursively into component sub-clusters or groups. Generally, the recursive process continues until either each individual observation or data element forms an individual cluster or until further splitting results in clusters or groups with a smaller number of observations than a predefined number or quantity. Specifically, nodes in the dendrogram that are available for further splitting are known as “open” nodes which undergo the analysis process in accordance with various embodiments of the present invention.

With reference to FIG. 1, a query step 104 determines if all nodes of the dendrogram are closed. Nodes become closed for one of two reasons, namely either a node is comprised of only a unitary data element or observation or the grouping or class of data elements is sufficiently homogonous that an adequate amount of separability is unattainable from within the group. If all of the nodes are closed, then no further partitioning is possible and processing stops 106 with the existing classification groups identified. When query 104 determines that one or more nodes remain open, a clustering process 108 splits the current node into sub-nodes for further analysis.

While, for example, a k-means clustering algorithm may utilize a Euclidean distance criterion as the initial clustering process 108, such a clustering process is sub-optimal in situations where the clusters are of unequal size and varying shapes. Furthermore, other clustering processes may also be utilized including, but not limited to, agglomerative clustering methods. The clustering process 108 results in groups of data elements or observations identified by their clustering membership or relationship. The clustering process 108 attempts to minimize the intracluster variabilities of intracluster data elements or observations and to maximize the intercluster variabilities between the respective clusters of data elements or observations.

While various clustering processes are acceptable, the k-means process is widely accepted. According to the k-means algorithm, the set of data elements is broken into a certain number of groups and the data elements are clustered or grouped. Other clustering processes are also acceptable including the Expectation Maximization (EM) algorithm which is useful for a dataset that generally observes the Gaussian probability law but is less accurate for a dataset that is comprised of non-Gaussian data elements or observations. Yet another clustering process is known as a k-medoid algorithm whose specifics are known by those of ordinary skill in the art.

The groupings or clusters resulting from clustering process 108 may be treated as pseudo-labeled samples for use in, for example, a statistical classification procedure, namely a classification process 109. Generally, in the clustering process 108 a mass of data elements is split into multiple groups and subjected to the grouping of, for example, a k-means clustering algorithm. As stated, the clustering process attempts to minimize an objective function by minimizing, for example, the sums-of-squares of a distance within a cluster and maximizing the distance between clusters. One exemplary objective function is a square error loss function to compute the variance within the group and between the groups. It is appreciated that the distance calculation is a Euclidian distance between the respective data elements.

The various embodiments of the present invention utilize, in addition to clustering schemes or techniques, a classification process 109 to enhance classification over traditional clustering-only processes. The present grouping method, in accordance with one or more embodiments of the present invention, utilizes a clustering process 108 followed by a classification process 109 to obtain homogenous data groups with a much lower group variance than is attainable with clustering techniques alone. The application of a classification process to the clustered data enables various data elements or observations to change classes based upon the misclassification refinements provided by the classification process 109.

The classification process 109 generally performs in iterative classification which measures class or grouping separability to determine if an adequate separation or distance is available between the various classes or groups. Once such a separation occurs, the selected groupings are accepted and processing continues to further analyze other groups or nodes within the hierarchal dendrogram.

A discriminant analysis process 110 is iteratively performed on the resulting clusters and may include one or more discriminate analysis techniques including, but not limited to, linear discriminate analysis (LDA) or quadratic discriminate analysis (QDA), collectively herein referred to as iterative discriminate analysis (IDA). Other discriminant analysis techniques may include “regularized techniques” as well as others that utilize the Fisher discriminant technique methodology. Further classification techniques may also be utilized including neural network classifiers and support vector machine classifiers, among others. The specifics of such alternative classification techniques are appreciated by those of ordinary skill in the art and are not further described herein.

Specifically, discriminant analysis techniques assume n samples, every sample and \vec{x} is of p dimension and is partitioned into k groups. Let nⱼ be the number of observations in the group j. Let \vec{m} denote the mean and Σⱼ denote the covariance matrix of group j respectively. It is also assumed that the p dimensional vector constitutes a sample random vector from a multivariate Gaussian distribution. Furthermore, utilization of QDA enables the classification of an observation vector into one of the k groups based on a decision rule that maximizes the posterior probability of correct classification given

$${d}_{j} ( x ) = ln ( \frac{{n}_{j}}{n} ) - \frac{1}{2} {( \vec{x} - {\vec{m}}_{j} )}^{T} {\sum }_{j}^{- 1} ( \vec{x} - {\vec{m}}_{j} ) , ( j = 1 , 2 , … , k )$$

The second term is called a Mahalanobis Distance statistic denoted by MDⱼ and nⱼ/n in the first term is the prior probability of cluster j. Unequal prior probabilities are assigned to the k clusters based on pre-clustering results. Note, that when the pooled covariance matrix Σₚ is used instead of the group specific covariance matrix Σⱼ used by QDA, the procedure simplifies to linear discriminant analysis (LDA).

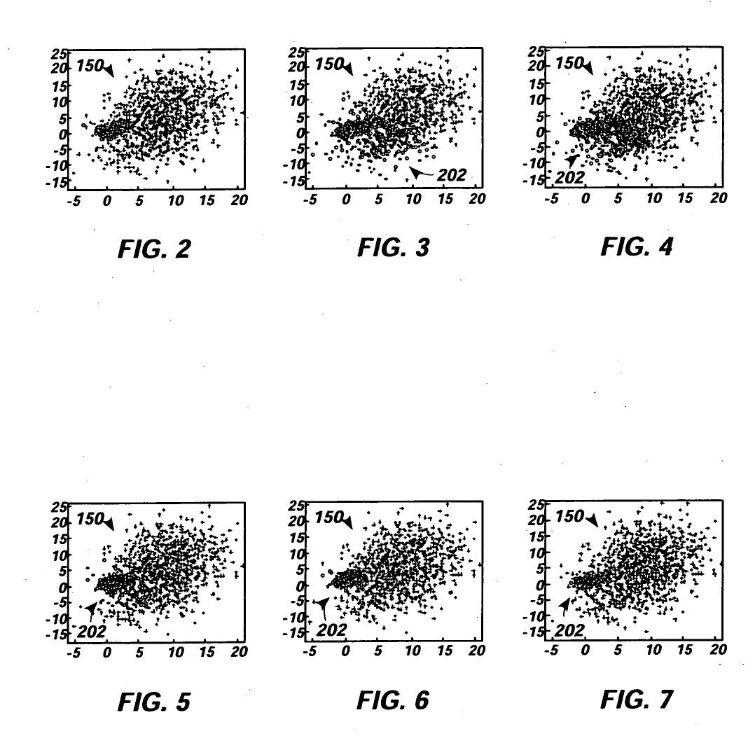

By way of example and not limitation, FIG. 2-FIG. 7 illustrate an exemplary partitioning of data elements or observations, in accordance with the grouping process of FIG. 1. By way of example, FIG. 2 illustrates an initial dataset 150 comprised of generated observations from 2 multivariate Gaussian distributions. The illustrated differences in data elements identifies the ideal groupings of data elements according to their respective characteristic or parameter/dimension of interest. Applying the method of FIG. 1, the partitioning of data elements or observations 150 (FIG. 2) following the clustering process 108 (FIG. 1) is illustrated in FIG. 3. It should be noted that the difference in classification of FIG. 3 from the initial dataset 150 illustrated in FIG. 2 highlights the very misclassification shortcomings of performing only a clustering process on the initial dataset 150. As illustrated in FIG. 3, many observations or data elements are misclassified resulting in a somewhat crude clustering or grouping of data elements. As illustrated, group 202 is over represented while group 200 is under represented. Such a large quantity of misclassifications or misgroupings of observations or data elements is minimized through the further application of the classification process 109 (FIG. 1).

The iterative application of discriminant analysis 110 is depicted in the iterative regrouping of the data observations, as illustrated with reference to FIGS. 4-7. As illustrated, the misclassification rate of the observations or data elements decreases within groups 200, 202 in each iteration as illustrated in FIGS. 4, 5 and 6 and then misclassification begins to increase in a subsequent iteration as illustrated in FIG. 7. By way of example, a phenomenon is illustrated with reference to FIGS. 4-7 known as a “predator-prey” phenomenon wherein with each subsequent iteration, a tendency exists for one group or class to dominate the other groups or classes until all data elements or observations are accumulated into one group or class. As this process of accumulation progresses, there becomes a point at which a minimum misclassification rate may be achieved. Therefore, it is desirable to terminate the iterative discriminate analysis 110 at an iteration wherein the minimum misclassification rate is achieved. Such a termination of iterations requires the formation of guidelines or stopping rules which can terminate the iterative discriminate analysis 110 at a desired or near optimal iteration.

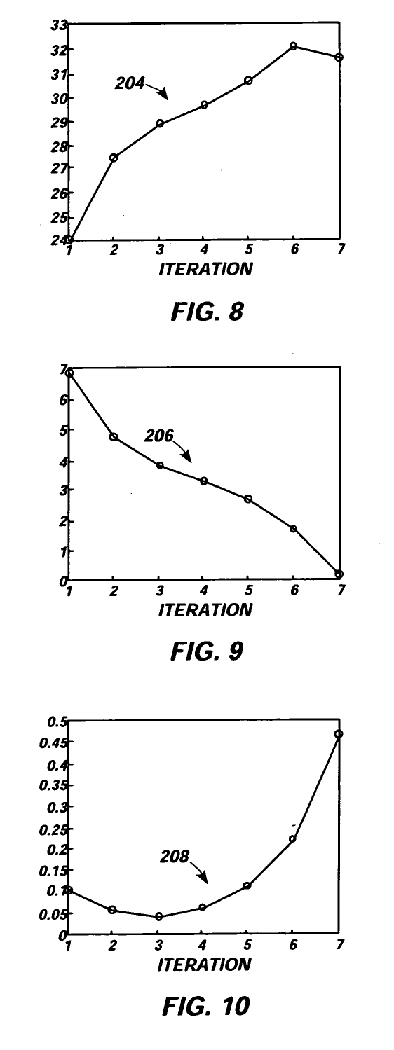

While various exemplary stopping rules may be derived, one exemplary stopping technique utilizes the formation of a trace of a sample covariance matrix. By definition, the trace of a covariance matrix is the sum of its diagonal elements. In application, such a stopping rule is implemented by monitoring the change in the trace of the cluster or class covariance of the two or more clusters. In accordance with the two cluster example, the traces of the respective covariance matrices are depicted in FIG. 8 and FIG. 9.

FIG. 8 is a graph of a trace 204 of group 200 (FIGS. 4-7), herein known as the predator group 200 and FIG. 9 illustrates a trace 206 of the covariance matrix of group 202 (FIG. 4) also herein known as the prey group 202. As illustrated, the trace 204 of the absorbing or predator grouping 200 (FIGS. 4-7) increases with each iteration and reaches a plateau. Furthermore, the trace 206 of FIG. 9 illustrates the covariance matrix of the prey grouping 202 (FIGS. 4-7) as tapering out and indicates an optimal or preferred classification as a misclassification rate 208 of FIG. 10 decreases at each iteration. Additionally, the trace 204 of FIG. 8 identifies a decreasing rate of slope which rate decreases gradually and coincides with minimized misclassification rate.

With reference to FIGS. 8-10, the effectiveness of such a stopping rule is noticed. FIG. 8 illustrates a decline in the rate of positive growth of trace 204 at an iteration 3 and trace 206 of FIG. 9 illustrates a decline in the rate of negative growth of the prey group 202 at iteration 3. Furthermore, FIG. 10 illustrates a minimization of the misclassification rate 208 at, for example, iteration 3.

Returning to FIG. 1, the classification process 109 further includes a class separability (C-S) measure computation process 112 for determining the relative separation of the classes or groupings resulting from the iterative discriminate analysis process 110 performed subsequent to clustering process 108. The C-S measure assists in determining whether the current classes resulting from the clustering process 108 and iterative discriminate analysis process 110 are adequately separated. Furthermore, class separability is used to determine if the proposed classes should be accepted when adequate separation exists or rejected with the closing of the node when adequate separation does not exist. The C-S measure is a calculation not only of the distance between the two or more classes as originally clustered and then further processed by iterative classification but additionally comprehends the orientation of the data within the two classes.

Computationally, class separability may be determined by letting x=(x₁, x₂, . . . , xₚ) be a p dimensional vector of attributes or features. Assume that there are a total of n such p-dimensional vectors constituting the dataset for clustering analysis. Class separability based on intuition, posits that the larger mean distance and smaller variance provides better separability. Based on such a hypothesis, many measures have been proposed. One example is from Dasgupta, S. Experiments with random projection. In Proceedings of the 16th Conference on Uncertainty in Artificial Intelligence, pages 143-151, Stanford, Calif., Jun.30- Jul. 3, 2000, where class separability is defined as:
d=∥μ₁−μ₂∥≧c√max{trace(Σ₁),trace(Σ₂)}
However, this definition doesn't consider the orientation of the model. Note that the orientation of the model is based on co-variations amongst the members of the p-dimensional data vector that is captured by the off-diagonal elements of the covariance matrix. Another measure of class separability may be given as:

$${d}_{mah} = \frac{1}{2} {( {μ}_{1} - {μ}_{2} )}^{T} {\sum }_{2}^{- 1} ( {μ}_{1} - {μ}_{2} ) + \frac{1}{2} {( {μ}_{2} - {μ}_{1} )}^{T} {\sum }_{1}^{- 1} ( {μ}_{2} - {μ}_{1} ) ,$$

which is an average of two Mahalanobis distances.

Yet another proposed distance from an analytic point of view is the Kullback-Leibler (K-L) divergence. Given two probability density functions, K-L distance is defined as:

$$\begin{matrix}d ( {f}_{1} \vert \vert {f}_{2} ) = \frac{1}{2} ln \frac{\vert {\sum }_{2} \vert}{\vert {\sum }_{1} \vert} - \frac{1}{2} {E}_{{x}_{1}} ( {{x}_{1}^{T} ( {\sum }_{1}^{- 1} - {\sum }_{2}^{- 1} )}^{′} {x}_{1} ) + \\ \frac{1}{2} ( {μ}_{1}^{T} {\sum }_{1}^{- 1} {μ}_{1} + {μ}_{2}^{T} {\sum }_{2}^{- 1} {μ}_{2} - 2 {μ}_{1}^{T} {\sum }_{2}^{- 1} {μ}_{2} )\end{matrix}$$

for the case when the data distributions are Gaussian, namely N(μ₁,Σ₁) and N(μ₂,Σ₂). Symmetry is introduced into the K-L distance,

$$d = \begin{matrix}d ( {f}_{1} \vert \vert {f}_{2} ) + d ( {f}_{2} \vert \vert {f}_{1} ) = - \frac{1}{2} {E}_{{x}_{1}} ( {x}_{1}^{T} ( {\sum }_{1}^{- 1} - {\sum }_{2}^{- 1} ) {x}_{1} ) - \\ \frac{1}{2} {E}_{{x}_{2}} ( {x}_{2}^{T} ( {\sum }_{1}^{- 1} - {\sum }_{2}^{- 1} ) {x}_{2} ) + {d}_{mah}\end{matrix}$$

Therefore, the proposed distance dₘₐₕ is part of the symmetric K-L distance. Also, a similarity between dₘₐₕ and the Bhattacharya distance exists.

To evaluate the usefulness of such a distance measure, covariance matrices may be fixed for the two clusters, with their mean distance increased in each step, resulting in a steadily increasing class separability measure between two classes. Then, the k-means with (k=2) is performed to see if the two classes can be successfully clustered and the misclassification rate is identified. Furthermore, the same example may be repeated using high dimensional data vectors.

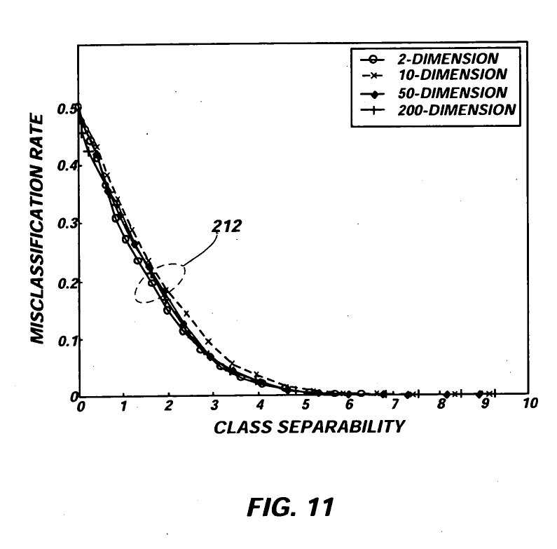

The results as illustrated agree with an expectation that larger class separability implies lower misclassification rate. FIG. 11 is a graphing of misclassification rate as a function of class separability. Specifically, plots 212 show that k-means only clustering process 108 (FIG. 1) yields lower misclassification rates within a range of the C-S distances. For instance, when class separability is in the range (2,5), the misclassification rate is generally between (0,0.15). The graph also shows that C-S distance does not depend on the dimension of the data vector as k=2, 10, 50, 200 are plotted as superimposed plots 212. The class separability distance is a useful parameter in the grouping method of the present invention. Therefore, since the C-S measure is independent of the dimensionality of the data vector, the proper selection of the C-S distance threshold may be simplified.

Returning to FIG. 1, a query 114 determines if the C-S measure exceeds a threshold which is a predetermined threshold defining a minimum separability distance that is acceptable for accepting 116 the classes or grouping resulting from clustering process 108 and iterative discriminate analysis process 110. When the C-S measure does not exceed a threshold, or when a query 118 determines that a sub-node includes a single data element, then the node is closed 120 and processing returns to evaluate other various open nodes, if any.

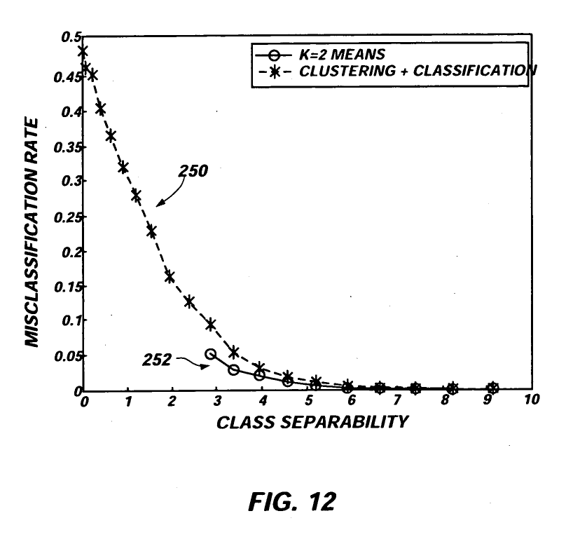

FIG. 12 illustrates a comparison of misclassifications of observations or data elements of clustering-only approaches in contrast to the combined clustering and classification approach described herein. Plot 250 illustrates a clustering only process, similar to the clustering process 108 of FIG. 1 which results in a higher misclassification rate than the classes formed from the combination of clustering and classification process as described, in accordance with the various embodiments of the present invention. As illustrated, the misclassification rates of plot 252 are significantly improved over plot 250 particularly for smaller class separability measures.

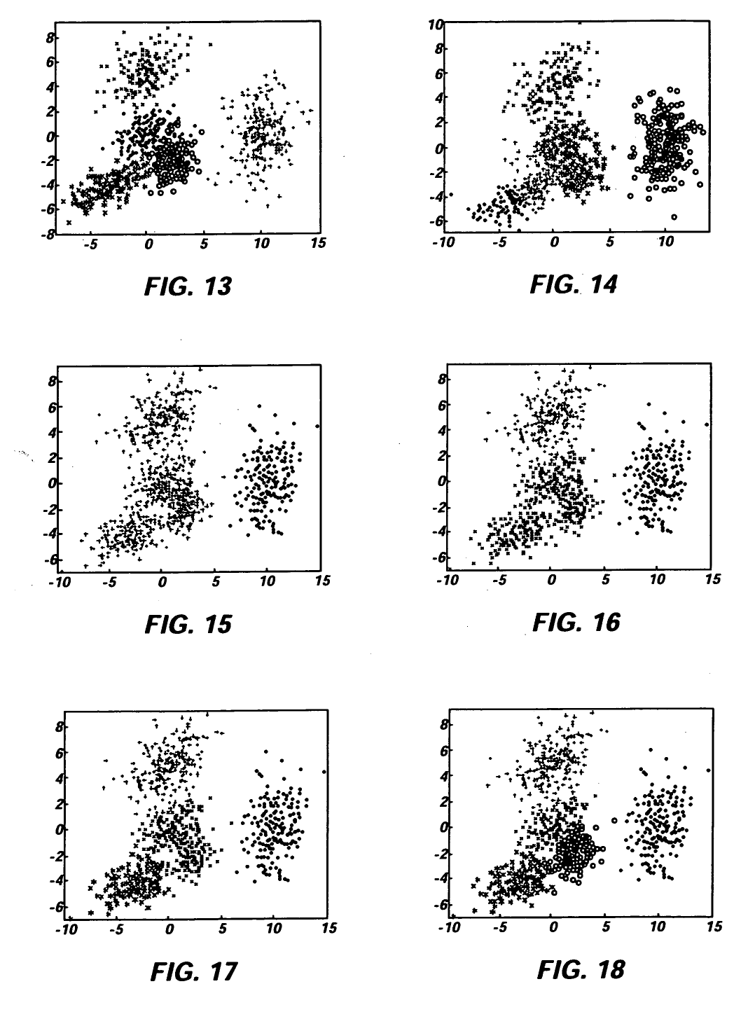

FIGS. 13-18 illustrate the grouping method, in accordance with various embodiments of the present invention, when applied to higher dimensional data elements. The present example illustrates randomly generated Gaussian distributions with sample sizes of 1,000 each in a ten dimensional space with a property that the four classes have their pair-wise class separability measure falling within a proper range, which in the present example is within the range (3, 6). Similar to the previous example of FIGS. 2-7, FIG. 13 illustrates the initial dataset with FIG. 14 illustrating the initial data following application of the clustering process 108 (FIG. 1). FIGS. 15-18 illustrate subsequent iterations of the iterative discriminate analysis process 110 (FIG. 1) for iterations 1-4, respectively. While misclassification still occurs through the various iterations, reduction in the misclassification rate has been illustrated to result in an improvement of about 30% on average over the clustering-only process.

Different embodiments of the present invention find various applications, an example of which includes e-business companies attempting to characterize the behavioral patterns of on-line shoppers in real time. By understanding shopper profiles, e-businesses may be able to serve-up web content dynamically to target marketing campaigns to a specific user and enhance the probability of a sale. Specifically, utilization of the grouping process, including the clustering and classification processes, would enable an e-business to segment visitors and build a predictive model to compute the likelihood of conversion of a sale based upon some key visitor attributes.

Specifically, modeling behavior of anonymous on-line visitors based on a variety of click stream attributes would enable better target marketing campaigns. Utilization of the grouping process described hereinabove, in conjunction with a logistic regression model to predict the propensity of an on-line visitor to buy based on some attributes have been found to strongly correlate. Application of some of the various embodiments of the present invention may be performed in two stages, first the grouping process as described hereinabove and second a logistic regression to estimate the likelihood of conversion or the propensity of a visitor to buy or engage in a purchase.

One exemplary dataset may consist of measured click stream attributes related to a session resulting from an on-line visitor clicking on a campaign ad. The attributes, and their derivatives used for analysis may include quantity of visits, view time per page, download time per page, status of cookies (whether enabled or disabled), errors, operating system, browser type and screen resolution, among others. The last three attributes alluded to above may be defined as technographics and may be combined to produce one composite herein known as a technographic index. Such an index may be generally considered to be a measure of the technical savvy of a visitor to the corresponding e-business website. By way of example, each technographic attribute may be rated on an ordinal scale of one-to-five with various attributes receiving higher ratings.

Once the various elements of the dataset have been grouped, a predictive model, such as a logistic regression model, may be utilized, for example, for the purposes of estimating a likelihood of conversion of a visitor on a given site. Logistic regression models attempt to correlate, for example, a buyer/non-buyer to the technographic index. The logistic model is an appropriate example due to its ability to comprehend the relationship between the categorical variable, that is to say buy/non-buy vs. any input attribute.

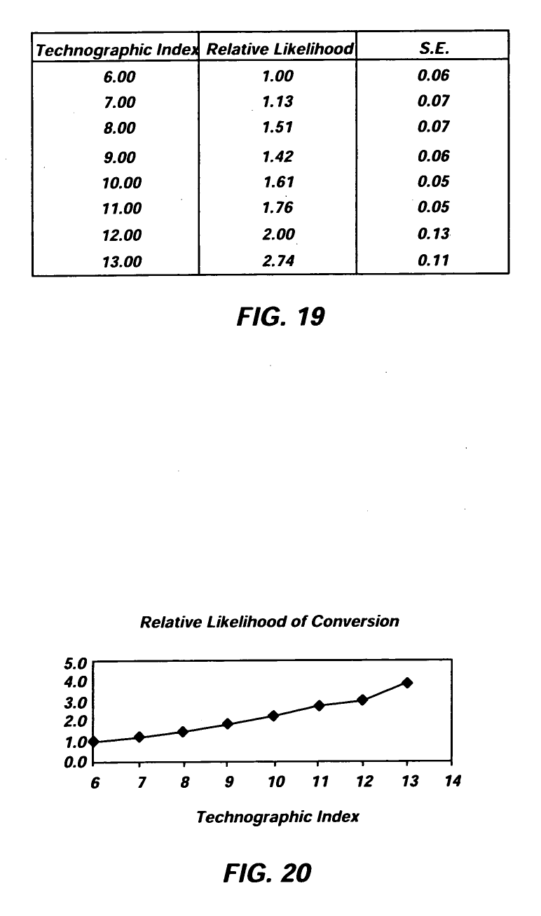

FIG. 19 is a table consisting of the relative likelihood of conversion (RLC) and a corresponding technographic index value. As illustrated in the present example, a positive relationship between the technographic index and the corresponding relative likelihood of conversion exists. It should be further noted that the table of FIG. 19 further consists of a standard error (s.e.) of the estimates of the probability of conversion. A methodology for computing the probability of conversion and its standard error may include the process of fitting the separate regression models over various random samples of sessions spanning different time periods with the estimation of the probability of conversion as a function of the technographic index. As illustrated, as the index rises, a corresponding increment in the likelihood of conversion is noticed. Furthermore, with reference to FIG. 20, it is deduced that a visitor with a technographic index equal, in the present example, to 13 is approximately 2.74 times more likely to buy than one with a value equal to 6. Such a correlatable finding enables, for example, an e-business site to attract technically savvy visitors by serving dynamically generated content based on a visitor's technographic profile.

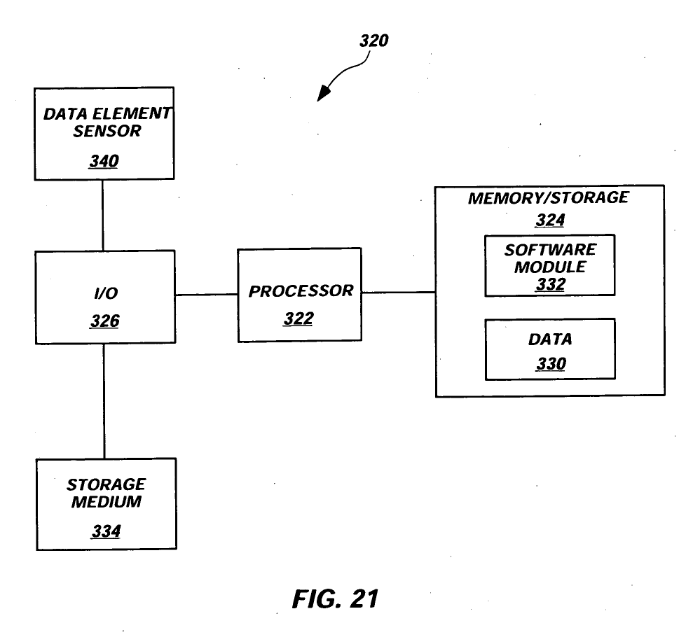

FIG. 21 is a high level block diagram of a system 320 for gathering and grouping data elements from a dataset, according to an embodiment of the present invention. System 320 includes a processor 322, a memory 324 and a set of input/output devices, such as a keyboard, a floppy disk drive, a printer and video monitor, represented by I/O block 326. Memory 324 includes a data storage area 330 and an instruction storage area illustrated as a software module 332 which includes a set of instruction which, when executed by processor 322, enable processor 322 to group data elements by the methods described hereinabove.

The executable code of software module 332 may be provided on a suitable storage medium 334, such as a floppy disk, compact disk or other computer-readable medium. The executable code is compatible with the resident operating system and hardware. The processor 322 reads the executable code from storage medium 334 using a suitable input device 326, and stores the executable code in software module 332.

The data elements or observations of the dataset to be grouped are entered via a suitable input device 326, either from a storage medium similar to storage medium 334, or directly from a data element sensor 340. If processor 322 is used to control sensor 340, then the data elements to be grouped may be provided directly to processor 322 by sensor 340. In either configuration, processor 322 may store the data elements in data storage area 330. According to the programming flow of the instruction in software module 332, processor 322 groups the data elements of the dataset according to the methods of some embodiments of the present invention.

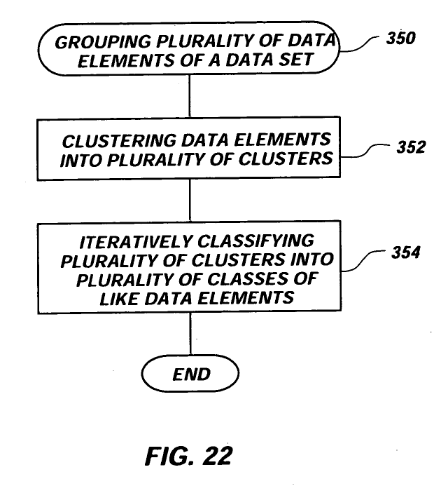

It will be understood from the forgoing that one embodiment of the present invention may include the method shown in FIG. 22. With reference to FIG. 22, a method 350 for grouping a plurality of data elements of a data set includes clustering 352 the dataset into a plurality of clusters. Each of the clusters includes at least one of the plurality of data elements. The method further includes iteratively classifying 354 the plurality of clusters into a plurality of classes of like data elements.

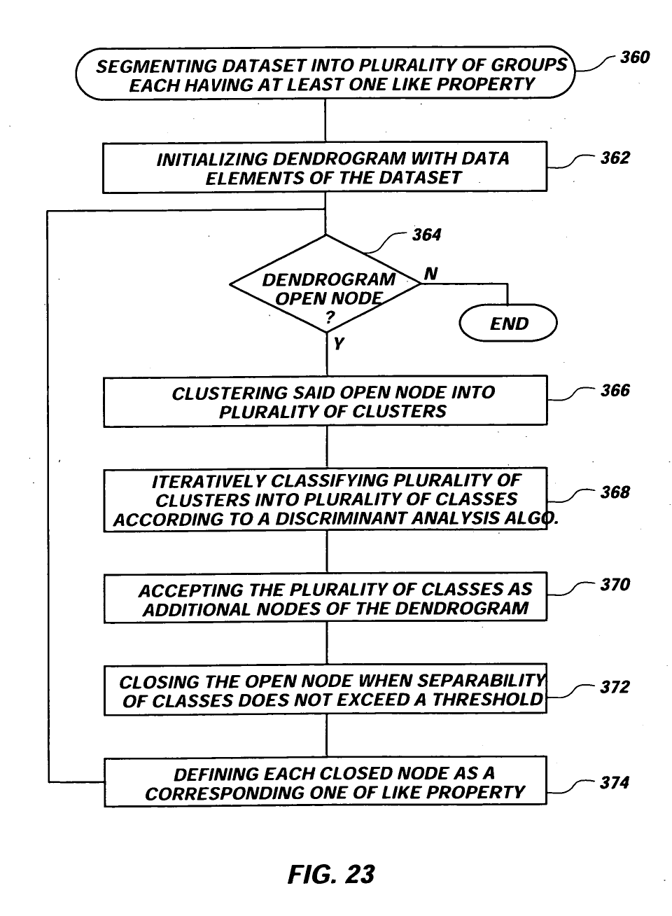

It will be further understood from the forging that another embodiment of the present invention my include the method shown in FIG. 23. With reference to FIG. 23, a method of segmenting a dataset including a plurality of data elements into a plurality of groups with each having at least one like property is described. The method 360 includes initializing 362 a dendrogram with the plurality of data elements of the dataset. A query 364 identifies each of the open nodes, and for each of the open nodes of the dendrogram, the open node is clustered 366 into a plurality of clusters with each including at least one of the plurality of data elements; For each open node, the plurality of clusters is further iteratively classified 368 into a plurality of classes according to a discriminant analysis algorithm configure to move at least one of the plurality of data elements from one of the plurality of classes to another one of the plurality of classes until misclassification of the plurality of data elements approaches a minimum.

Additionally, for each of the open nodes, the plurality of classes is accepted 370 into a plurality of classes according to a discriminate analysis algorithm configured to move at least one of the plurality of data elements from one of the plurality of classes to another one of the plurality of classes until misclassification of the plurality of data elements approaches a minimum. Furthermore, for each of the open nodes, when the separability of the classes does not exceed the defined threshold and when one of the classes comprises a single one of the plurality of data elements, then the open node is closed 372. Thereafter, the method defines 374 each closed node of the dendrogram as a corresponding one of the plurality of groups of the plurality of data elements having at least one like property.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

1. A method for grouping a plurality of data elements of a dataset, comprising:
clustering said dataset into a plurality of clusters, each of said plurality of clusters comprising at least one of said plurality of data elements; and
iteratively classifying said plurality of clusters into a plurality of classes of like data elements.

2. The method of claim 1 wherein said clustering comprises clustering said dataset according to one of a k-means, expectation maximization, and k-medoid clustering algorithm.

3. The method of claim 1 wherein said iteratively classifying comprises iteratively classifying according to an iterative discriminant analysis algorithm said plurality of clusters into a plurality of classes.

4. The method of claim 3 wherein said iterative discriminant analysis algorithm comprises one of linear discriminant analysis algorithm and quadratic discriminant analysis algorithm.

5. The method of claim 1 wherein said iteratively classifying comprises iteratively classifying said plurality of clusters until misclassification of said plurality of data elements is minimized.

6. The method of claim 5 wherein said misclassification is calculated from a determination of at least a sample of covariance matrix traces of each of said plurality of classes.

7. The method of claim 1 further comprising:
measuring a class separability measure of said plurality of classes; and
accepting said plurality of classes as said grouping of said plurality of data elements when said class separability measure exceeds a predetermined class separation threshold.

8. The method of claim 7 wherein said measuring said class separability measure is calculated according to an average of at least two Mahalanobis distances.

9. The method of claim 7 wherein said measuring said class separability measure is calculated according to one of a Dasgupta measure, Mahalanobis measure, Kullback-Leibler measure and a Bhattacharya measure.

10. A method of segmenting a dataset including a plurality of data elements into a plurality of groups each having at least one like property, comprising:
initializing a dendrogram with said plurality of data elements of said dataset;
for each open node of said dendrogram,
clustering said open node into a plurality of clusters each including at least one of said plurality of data elements;
iteratively classifying said plurality of clusters into a plurality of classes according to a discriminant analysis algorithm configured to move at least one of said plurality of data elements from one of said plurality of classes to another one of said plurality of classes until misclassification of said plurality of data elements approaches a minimum;
accepting said plurality of classes as additional nodes of said dendrogram when separability of said classes exceeds a defined threshold; and
closing said open node when said separability of said classes does not exceed said defined threshold and when one of said classes comprises a single one of said plurality of data elements; and
defining each closed node of said dendrogram as a corresponding one of said plurality of groups of said plurality of data elements having at least one like property.

11. The method of claim 10, wherein said clustering comprises clustering according to one of a partitioning and hierarchical algorithm.

12. The method of claim 10, wherein said clustering comprises clustering according to a k-means algorithm.

13. The method of claim 10 wherein said iteratively classifying comprises iteratively classifying according to one of linear discriminant analysis algorithm and quadratic discriminant analysis algorithm.

14. The method of claim 10 wherein said misclassification of said plurality of data elements is calculated from an analysis of covariance traces of each of said plurality of classes.

15. The method of claim 10 wherein said accepting comprises:
measuring a class separability measure of said plurality of classes; and
accepting said plurality of classes as additional nodes of said dendrogram when said class separability measure exceeds a predetermined class separation threshold.

16. The method of claim 15 wherein said measuring said class separability measure is calculated according to an average of at least two Mahalanobis distances.

17. The method of claim 15 wherein said measuring said class separability measure is calculated according to one of a Dasgupta measure, Mahalanobis measure, Kullback-Leibler measure and a Bhattacharya measure.

18. A system for grouping a plurality of data elements forming a dataset into a plurality of groups, comprising:
a sensor for detecting said plurality of data elements to form said dataset;
a memory for storing said plurality of data elements; and
a processor for:
clustering said dataset into a plurality of clusters, each of said plurality of clusters comprising at least one of said plurality of data elements; and
iteratively classifying said plurality of clusters into a plurality of classes of like data elements.

19. A computer-readable medium having computer-readable instructions thereon for grouping a plurality of data elements of a dataset, comprising:
clustering said dataset into a plurality of clusters, each of said plurality of clusters comprising at least one of said plurality of data elements; and
iteratively classifying said plurality of clusters into a plurality of classes of like data elements.

20. The computer-readable medium of claim 19 wherein said computer-executable instructions for clustering comprise computer-executable instructions for clustering according to one of a partitioning and hierarchical algorithm.

21. The computer-readable medium of claim 20 wherein said computer-executable instructions for clustering comprises clustering according to a k-means algorithm.

22. The computer-readable medium of claim 19 wherein said computer-executable instructions for iteratively classifying comprises computer-executable instructions for iteratively classifying according to one of linear discriminant analysis algorithm and quadratic discriminant analysis algorithm.

23. A system for grouping a plurality of data elements of a dataset, comprising:
a means for clustering said dataset into a plurality of clusters, each of said plurality of clusters comprising at least one of said plurality of data elements; and
a means for iteratively classifying said plurality of clusters into a plurality of classes of like data elements.
